(19) United States
(12) Patent Application Publication
(10) Pub. No.: US 2013/0247192 A1
(43) Pub. Date: Sep. 19, 2013

(54) SYSTEM AND METHOD FOR BOTNET DETECTION BY COMPREHENSIVE EMAIL BEHAVIORAL ANALYSIS

(71) Applicants: Sven Krasser, Atlanta, GA (US); Yuchun Tang, Johns Creek, GA (US); Zhenyu Zhong, Alpharetta, GA (US)

(72) Inventors: Sven Krasser, Atlanta, GA (US); Yuchun Tang, Johns Creek, GA (US); Zhenyu Zhong, Alpharetta, GA (US)

(21) Appl. No.: 13/037,988

(22) Filed: Mar. 1, 2011

(51) Int. Cl. G06F 21/00

(52) U.S. Cl. 726/23

(57) ABSTRACT

A method is provided in one example embodiment that includes receiving message sender traits associated with email senders, and receiving a dataset of known malware identifiers and network addresses from a spamtrap. The message sender traits may include behavior features and/or content resemblance factors in various embodiments. The method further includes classifying the email senders as malicious or benign based on the behavior features, and further classifying the malicious senders by malware identifiers based on similarity of content resemblance factors and the dataset of known malware identifiers and network addresses. In certain specific embodiments, a supervised classifier, such as a support vector machine, may be used to classify the malicious senders by malware identifiers.

### TECHNICAL FIELD

This disclosure relates in general to the field of network security, and more particularly, to a system and a method for botnet detection by comprehensive behavioral analysis of electronic mail.

### BACKGROUND

The field of network security has become increasingly important in today's society. The Internet has enabled interconnection of different computer networks all over the world. The ability to effectively protect and maintain stable computers and systems, however, presents a significant obstacle for component manufacturers, system designers, and network operators. This obstacle is made even more complicated due to the continually-evolving array of tactics exploited by malicious operators. Of particular concern more recently are botnets, which may be used for a wide variety of malicious purposes. Once malicious software (e.g., a bot) has infected a host computer, a malicious operator may issue commands from a “command and control server” to control the bot. Bots can be instructed to perform any number of malicious actions such as, for example, sending out spam or malicious emails from the host computer, stealing sensitive information from a business or individual associated with the host computer, propagating the botnet to other host computers, and/or assisting with distributed denial of service attacks. In addition, a malicious operator can sell or otherwise give other malicious operators access to a botnet through the command and control servers, thereby escalating the exploitation of the host computers. Consequently, botnets provide a powerful way for malicious operators to access other computers and to manipulate those computers for any number of malicious purposes. Security professionals need to develop innovative tools to combat such tactics that allow malicious operators to exploit computers.

### BRIEF DESCRIPTION OF THE DRAWINGS

To provide a more complete understanding of the present disclosure and features and advantages thereof, reference is made to the following description, taken in conjunction with the accompanying figures, wherein like reference numerals represent like parts, in which:

FIG. 1 is a simplified block diagram illustrating an example embodiment of a network environment in which botnets may be detected by comprehensive behavioral analysis of electronic mail in accordance with this specification;

FIG. 2 is a simplified block diagram illustrating additional details associated with one potential embodiment of network environment in accordance with this specification;

FIG. 3 is a simplified block diagram illustrating example operations that may be associated with detecting and analyzing bots in one embodiment of a network environment in accordance with this specification;

FIG. 4 is a simplified flowchart illustrating example operations associated with message fingerprinting in one embodiment of a network environment in accordance with this specification; and

FIG. 5 is an illustration of two example spam messages delivered by two different senders with similar feature elements.

### DETAILED DESCRIPTION OF EXAMPLE EMBODIMENTS

### Overview

A method is provided in one example embodiment that includes receiving message sender traits associated with email senders, and receiving a dataset of known malware identifiers and network addresses from a spamtrap. The message sender traits may include behavior features and/or content resemblance factors in various embodiments. The method further includes classifying the email senders as malicious or benign based on the behavior features, and further classifying the malicious senders by malware identifiers based on similarity of content resemblance factors and the dataset of known malware identifiers and network addresses. In certain specific embodiments, a supervised classifier, such as a support vector machine, may be used to classify the malicious senders by malware identifiers. In yet other particular embodiments, the content resemblance factors may be message fingerprints and the behavior features indicate message distribution of each email sender and the delivery speed of each email sender. Noisy feature elements and feature elements originating from a relatively small number of email senders may also be pruned from content resemblance factors in some embodiments.

### Example Embodiments

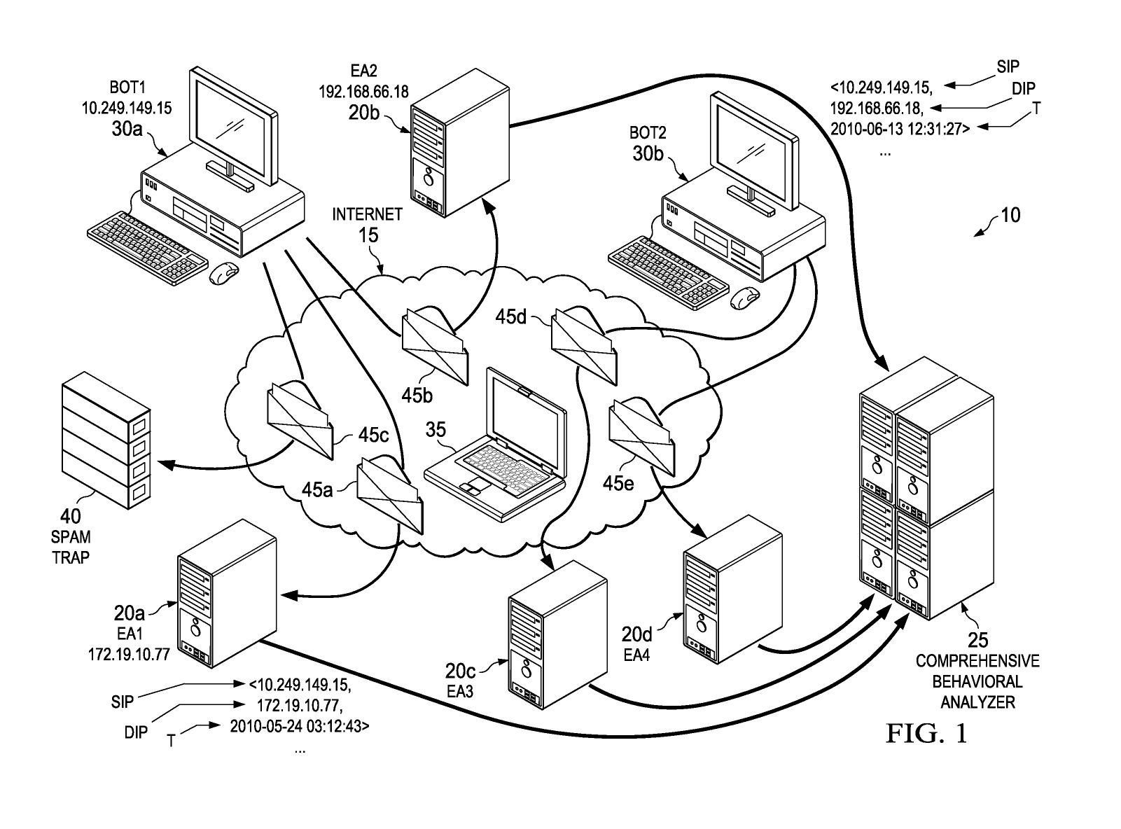

Turning to FIG. 1, FIG. 1 is a simplified block diagram of an example embodiment of a network environment 10 in which botnets may be detected by comprehensive behavioral analysis of electronic mail (“email”). Network environment 10 includes Internet 15, email gateway appliances (EAs) 20a-d, a behavioral analyzer element 25, bot hosts 30a-b, a workstation 35, and a spamtrap 40. In general, a bot host may be any type of computer that is compromised by malicious software (“malware”), which may be under the control of a remote command and control (C&C) server. Each of EAs 20a-d, analyzer element 25, bot hosts 30a-b, workstation 35, and spamtrap 40 may have associated network addresses that uniquely identify each element in network environment 10, such as Internet Protocol (IP) addresses. For example, bot host 30a may be associated with an IP address of 10.249.149.15, EA 20a may be associated with an IP address of 172.19.10.77, and EA 20b may be associated with an IP address of 192.168.66.18. Note that these example addresses are limited to the private IPv4 range for illustrative purposes, but the use of public addresses is anticipated in many embodiments. As will be discussed in more detail below, EAs 20a-d may periodically receive email messages, such as messages 45a-e, from bot host 30a or bot host 30b. EAs 20a-d may forward certain information about these messages to analyzer element 25, including a sender IP (SIP) address, a destination IP (DIP) address, and a time stamp T.

Each of the elements of FIG. 1 may couple to one another through simple interfaces or through any other suitable connection (wired or wireless), which provides a viable pathway for network communications. Additionally, any one or more of these elements may be combined or removed from the architecture based on particular configuration needs. Network environment 10 may include a configuration capable of transmission control protocol/Internet protocol (TCP/IP) communications for the transmission or reception of packets in a network. Network environment 10 may also operate in conjunction with a user datagram protocol/IP (UDP/IP) or any other suitable protocol where appropriate and based on particular needs.

Before detailing the operations and the infrastructure of FIG. 1, certain contextual information is provided to offer an overview of some problems that may be encountered when attempting to detect and analyze botnets. Such information is offered earnestly and for teaching purposes only and, therefore, should not be construed in any way to limit the broad applications for the present disclosure.

Botnets have become a serious Internet security problem. In many cases they employ sophisticated attack schemes that include a combination of well-known and new vulnerabilities. Usually, a botnet is composed of a large number of bots that are controlled through various channels, including Internet Relay Chat (IRC) and peer-to-peer (P2P) communication, by a particular botmaster using a C&C protocol. Once machines are exploited and become bots, they are often used to commit Internet crimes such as sending spam, launching DDoS attacks, phishing attacks, etc.

Botnet attacks generally follow the same lifecycle. First, desktop computers are compromised by malware, often by drive-by downloads, Trojans, or un-patched vulnerabilities. The term “malware” generally includes any software designed to access and/or control a computer without the informed consent of the computer owner, and is most commonly used as a label for any hostile, intrusive, or annoying software such as a computer virus, spyware, adware, etc. Once compromised, the computers may then be subverted into bots, giving a botmaster control over them. The botmaster may then use these computers for malicious activity, such as spamming.

Having a realtime botnet tracking system can prevent attacks originated from botnets, or at least reduce the risks of exploits from malicious contact. It can also provide researchers with valuable behavioral history of botnet IPs.

Under certain circumstances, internal activities of botnets may be observed to understand how they operate. For example, a botnet may be observed by taking over C&C channels and intercepting communications between bots and their C&C server. Such approaches, however, often require botnet related malware binaries to be installed and run in a sandboxed environment so that analysis can be performed securely. Moreover, active botnets can be very difficult to infiltrate and their protocols can change frequently. Thus, this approach can be very complex and time consuming, and generally is not able to provide comprehensive information on the numerous botnets that are active globally at any given time.

Much can also be learned from observing and analyzing the external behavior of botnets. This approach may be used to study different kinds of attack patterns. For example, it can be used to discover spam email sending patterns, correlation between inbound and outbound email, clustering of both TCP level traffic and application level traffic, etc.

These approaches are often confined to a local network, because building a distributed environment and minimizing the liability of potential harm to the rest of the Internet can require tremendous resources. Thus, at least within a short term, it is difficult to achieve a global visibility of botnet behavior using these approaches.

In accordance with one embodiment, network environment 10 can overcome these shortcomings (and others) by providing comprehensive behavioral analysis of email. A host's botnet membership may be inferred based on the host's behavior as observed from its email traffic patterns. The email traffic is observed from a network of email sensors, which may be deployed in EAs or other network elements throughout the Internet. The email traffic information may be aggregated and correlated to indicate the existence and the territory of various botnets.

Message sender traits, including behavioral features and content resemblance, can be captured in email traffic traces for effective email sender and botnet classification. To capture email sender behavior, EAs can record email SIPs, DIPs, time stamps, and other data when email arrives. Based on the recorded information, behavior features can be extracted. The types of behavior features that can be extracted may vary based on data available from external network infrastructure, but may include, for example, the number of DIPs to which a SIP sends messages, the number of messages that one SIP sends, the message sizes from a SIP, etc. With an appropriate classifier, behavioral analysis of this traffic may be used to classify each bot into specific botnets without detailed information about the botnet or any prior knowlege of any C&C communication, based on a comparison of sending behavior. For example, sending behavior of bot host 30a and bot host 30b may be compared based on data collected by different EAs, such as EA 20a and 20c. If bot host 30b exhibits sending behavior similar to bot host 30a, then both may be attributed to the same botnet. Classifiers may include, for example, support vector machines (SVMs), decision trees, decision forests, or neural networks.

Behavioral analysis may be extended further to include a resemblance factor of message content with a message transformation algorithm. A content resemblence factor may be used to infer similarity between two messages originating from the same botnet while protecting the privacy of legitimate messages. Message fingerprints are one example of a content resemblance factor. Message content analysis can then be performed based on resemblance factors, such as fingerprints, rather than original content, which may protect the privacy of legitimate content. The fingerprint is sufficiently resilient to the obfuscation that spammers usually apply to the content in order to circumvent spam filters. This technique can ensure that if the message content of two email messages differs by only a small amount, then the fingerprints will also differ by only a small amount, and it can be inferred that two SIPs that send similar spam messages belong to the same botnet.

Rule-based elements may also be combined with classification of behavioral features to achieve global visibility into different kinds of botnets. For example, a spamtrap may be used in certain embodiments to correlate spam messages with particular botnets. By applying known heuristics (e.g., the presence of certain text in email headers, the presence of certain text in email bodies, the order of email headers, certain non-standard compliant behavior when interacting with a spamtrap mail server, etc.) on spam received in the spamtrap, a dataset with known botnet membership can be obtained. Since the spam messages originate from a known IP address, a relationship between the address and a botnet can be established.

In one embodiment of network environment 10, a two-level supervised behavioral classifier may be used to compare behavior features and message content fingerprints from email traffic traces with spamtrap samples. This method does not require any knowledge of C&C communications between bots.

In such an embodiment, the first level classifier may be a binary classifier that discriminates benign SIPs from malicious ones, based solely on email sender behavior. The outcome of this first-level classification generally includes a group of IP addresses that are identified as malicious. The second-level classifier targets multi-objectives prediction, which can classify malicious SIPs into several individual botnets if the SIPs' behavior is substantially similar to that of a particular known bot. The second-level classifier can use email sender behavior, but may also use message content fingerprints collected from email traces and IP addresses with associated labels collected from a spamtrap. Once a classification model is generated, the second level classifier can classify the malicious IP addresses obtained from the first level classifier to group IP addresses into botnets.

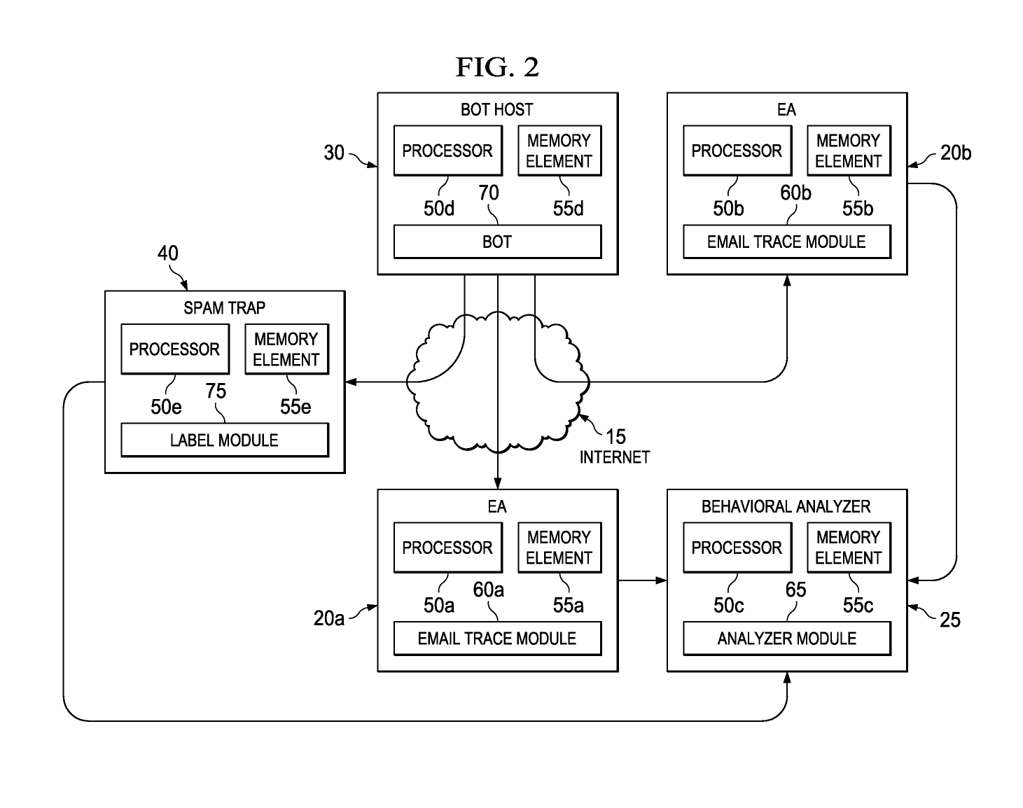

Turning to FIG. 2, FIG. 2 is a simplified block diagram illustrating additional details associated with one potential embodiment of network environment 10. FIG. 2 includes Internet 15, EAs 20a-b, analyzer element 25, bot host 30, and spamtrap 40. Each of these elements includes a respective processor 50a-e, a respective memory element 55a-e, and various software elements. More particularly, email trace modules 60a-b may be hosted by EAs 20a-b, analyzer module 65 may be hosted by analyzer element 25, bot 70 may be hosted by bot host 30, and label module 75 may be hosted by spamtrap 40.

In one example implementation, EAs 20a-b, analyzer element 25, bot host 30, and/or spamtrap 40 are network elements, which are meant to encompass network appliances, servers, routers, switches, gateways, bridges, loadbalancers, firewalls, processors, modules, or any other suitable device, component, element, or object operable to exchange information in a network environment. Moreover, the network elements may include any suitable hardware, software, components, modules, interfaces, or objects that facilitate the operations thereof. This may be inclusive of appropriate algorithms and communication protocols that allow for the effective exchange of data or information.

In regards to the internal structure associated with network environment 10, each of EAs 20a-b, analyzer element 25, bot host 30, and/or spamtrap 40 can include memory elements (as shown in FIG. 2) for storing information to be used in the operations outlined herein. Additionally, each of these devices may include a processor that can execute software or an algorithm to perform the activities as discussed herein. These devices may further keep information in any suitable memory element [random access memory (RAM), ROM, EPROM, EEPROM, ASIC, etc.], software, hardware, or in any other suitable component, device, element, or object where appropriate and based on particular needs. Any of the memory items discussed herein should be construed as being encompassed within the broad term ‘memory element.’ The information being tracked or sent by EAs 20a-b, analyzer element 25, bot host 30, and/or spamtrap 40 could be provided in any database, register, control list, or storage structure, all of which can be referenced at any suitable timeframe. Any such storage options may be included within the broad term ‘memory element’ as used herein. Similarly, any of the potential processing elements, modules, and machines described herein should be construed as being encompassed within the broad term ‘processor.’ Each of the network elements can also include suitable interfaces for receiving, transmitting, and/or otherwise communicating data or information in a network environment.

In one example implementation, EAs 20a-b, analyzer element 25, bot host 30, and/or spamtrap 40 include software (e.g., as part of analyzer module 65, etc.) to achieve, or to foster, botnet detection and analysis operations, as outlined herein. In other embodiments, this feature may be provided externally to these elements, or included in some other network device to achieve this intended functionality. Alternatively, these elements may include software (or reciprocating software) that can coordinate in order to achieve the operations, as outlined herein. In still other embodiments, one or all of these devices may include any suitable algorithms, hardware, software, components, modules, interfaces, or objects that facilitate the operations thereof.

Note that in certain example implementations, botnet detection and analysis functions outlined herein may be implemented by logic encoded in one or more tangible media (e.g., embedded logic provided in an application specific integrated circuit [ASIC], digital signal processor [DSP] instructions, software [potentially inclusive of object code and source code] to be executed by a processor, or other similar machine, etc.). In some of these instances, memory elements [as shown in FIG. 2] can store data used for the operations described herein. This includes the memory elements being able to store software, logic, code, or processor instructions that are executed to carry out the activities described herein. A processor can execute any type of instructions associated with the data to achieve the operations detailed herein. In one example, the processors [as shown in FIG. 2] could transform an element or an article (e.g., data) from one state or thing to another state or thing. In another example, the activities outlined herein may be implemented with fixed logic or programmable logic (e.g., software/computer instructions executed by a processor) and the elements identified herein could be some type of a programmable processor, programmable digital logic (e.g., a field programmable gate array [FPGA], an erasable programmable read only memory (EPROM), an electrically erasable programmable ROM (EEPROM)) or an ASIC that includes digital logic, software, code, electronic instructions, or any suitable combination thereof.

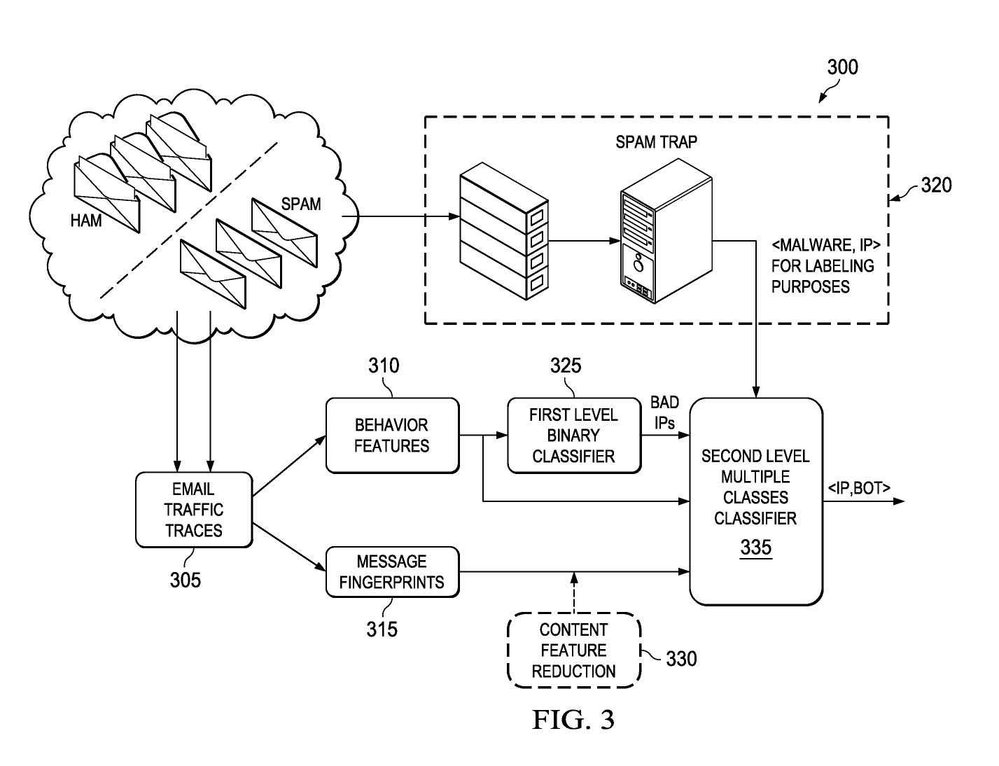

FIG. 3 is a simplified block diagram 300 illustrating example operations that may be associated with detecting and analyzing bots in one embodiment of network environment 10. Email traffic traces may be collected and forwarded at 305. When a message arrives, email sender behavior features can be captured and forwarded at 310, and message fingerprints captured and forwarded at 315. At 320, spamtrap samples may be collected and labeled based on email sender IP addresses. Note that both email traffic collection at 305 and spamtrap sample collection at 320 can be on-going, parallel operations. They may also be carried out by various external or third-party resources. IP addresses may be classified as malicious or benign at 325, based on email sender IP address behavior. Extraneous feature elements (FEs) that are likely to be unnecessary for classification can be removed from message fingerprints at 330. For example, fingerprints exclusively associated with good senders as determined in classification at 325 can be removed for performance reasons. IP addresses of email senders may be further classified by botnet association at 335, based on the first classification at 325, message fingerprints captured at 315, and the spamptrap sample collection at 320. Due to the high dimension and sparseness of the feature space for each IP address, an SVM or other supervised machine learning classifier is preferably used for analysis, although principle component analysis may be used in some embodiments. Additional details associated with these example operations are provided below.

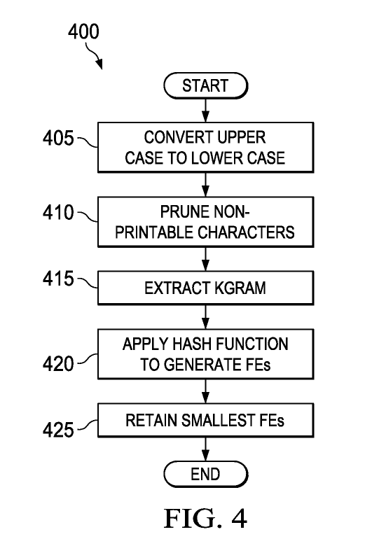

FIG. 4 is a simplified flowchart 400 illustrating example operations associated with message fingerprinting in one embodiment of network environment 10, as may be done at 315 of flowchart 300. As noted already, message fingerprinting may be used in certain embodiments of network environment 10 to protect the privacy of legitimate messages. However, any suitable technique for identification of document resemblance, such as shingle-based fingerprints or n-gram similarlity modeling, may be used instead. In the particular embodiment shown in FIG. 4, a winnowing fingerprint algorithm can be used, in which each email message may be normalized by converting all upper case characters to lower case at 405 and pruning non-printable characters at 410. Kgrams may be obtained at 415. In one embodiment, a kgram may be defined as a consecutive subsequence of the message with length k. By repeatedly shifting the kgram by one byte starting from the beginning of the message to the end of the message, N-k+1 kgrams can be obtained, where N is the length of the message and k<N. Then, a hash function may be applied on each kgram at 420 to generate N-k+1 FEs. The smallest FEs can be retained at 425 as the winnowing fingerprint for the message. Thus, the winnowing fingerprint in this embodiment is essentially a set of FEs, each FE being a 64-bit hash of the normalized message. In one embodiment, MD5 may be used to calculate the hash.

Additionally, two hashes may be calculated for each kgram. The first hash can be used to determine the smallest FEs and the second hash may be used as the actual FEs. This approach may provide several advantages. For example, FEs may be more evenly distributed throughout the space of possible values. Second, in the rare case of a collision of FEs, it is less likely that both are picked with the same probability since their first hash is likely to differ.

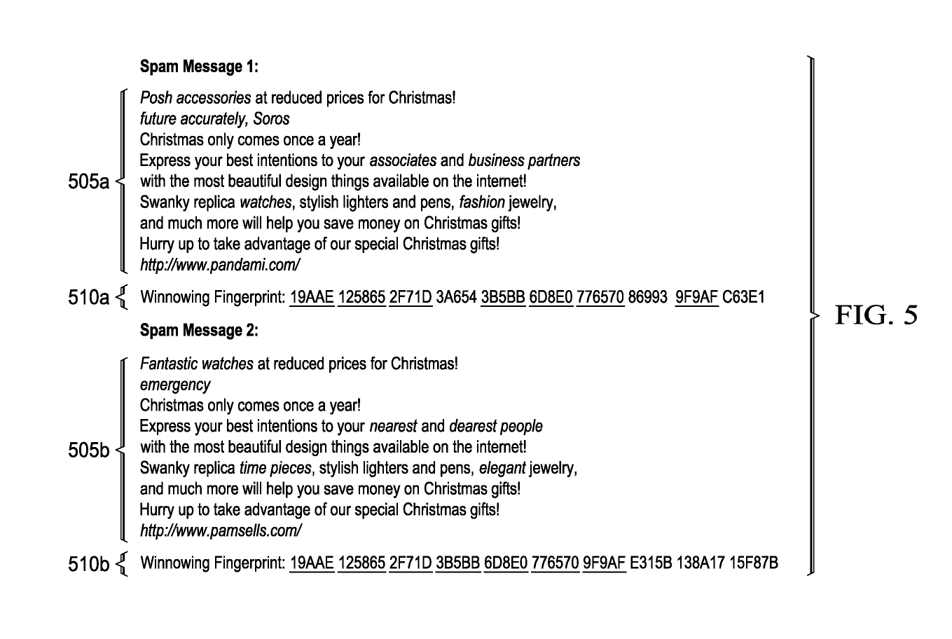

FIG. 5 demonstrates an example of two spam messages 505a and 505b delivered by two different SIPs. The italicized tokens indicate the differences between these two messages. Below each message is a respective winnowing fingerprint 510a and 510b, which generally comprises FEs that may be generated by the winnowing fingerprint algorithm of FIG. 4, for example. Based on a comparison of the FEs, it can be determined that these two messages share seven out of ten (70%) of the resulting FEs, which indicates a high probability that the two messages come from the same botnet.

A quick classification of botnets and other threats is highly desirable since many threats on the Internet are ephemeral and fast-moving. One significant challenge for quick classification of bot-based message content is the large number of features generated from email content. Millions of messages may need to be processesed at the same time and each FE can increase the dimensionality of the feature space, which can easily create a classification problem that cannot be computed in a reasonable time. Noisy FEs can also decrease classification performance. In accordance with one embodiment, network environment 10 can overcome this challenge by pruning FEs that are unnecessary for classification, as may done at 330 in FIG. 3. FEs in such an embodiment may be pruned in two steps, as described below.

First, a threshold may be defined such that FEs are pruned unless they are seen from a number of SIPs that exceeds the threshold value. Botmasters typically employ a large number of bots in spam campaigns to assure that they can achieve high throughput and delivery rates even if parts of the botnet are blacklisted, which implies that the FEs associated with spam campaigns are typically seen from a large number of SIPs. Thus, FEs from a relatively small number of SIPs can be pruned with a high degree of confidence that they are not associated with a spam campaign.

Second, FEs that are known to be from benign, whitelisted SIPs (as determined by classification at 325, for example) can be pruned to reduce noisy FEs. Noisy FEs may be the result of automatic signatures or confidentiality statements attached to the end of messages by many companies, for example. Another potential source of noisy FEs is the markup language used by many mail user agents, which can contain large blocks of boilerplate markup and styling. Such messages are likely to contain elements of similarity, but are nonetheless legitimate messages from reputable senders that do not belong to any botnet. Another potential problem may be presented by legitimate high-volume senders. Such senders can deliver a large number of different messages, which in turn can result in a large number of FEs. The large size of the FE space can significantly reduce classification performance. Thus, in some embodiments, only FEs that have been seen from potentially malicious SIPs or SIPs that are neither known to be benign nor malicious yet are be retained for further analysis.

Referring again to FIG. 3 for context, IP addresses can be classified as malicious or benign at 325, based on email sender IP address behavior features extracted from various sources. Each IP can be regarded as key, and behavior and content features may be aggregated as value. Since many botnets target desktop machines, constraints of system resources across the population are fairly equal and bots in general display spam sending patterns with a high degree of similarity to each other. For example, similarities may include the amount of spam messages a bot sends and/or the number of recipients per sender (i.e., message distribution), the content of spam messages a bot sends, the spam delivery speed of a bot, average message size, and/or standard deviation of message size, etc. These types of message features may be computed, for example, based on the number of DIPs to which a SIP sends messages, the number of messages one SIP sends, average message size sent from a SIP, standard deviation of message size sent from a SIP, the sum of distinct email subjects sent from a SIP (as inferred from the number of unique subject hashes), a count of distinct EHLO (i.e., command in Extended Simple Mail Transfer Protocol (ESMTP) to open transmission between a client and a server) values in messages sent from a SIP (as inferred from the number of unique EHLO hashes transmitted in reputation queries from EAs and derived from hashing the string submitted by the sender as part of the EHLO command), and/or a reputation score (available from several commercial services). In addition to common spam sending behavior, timing may also be considered as an important feature to indicate the transition of spam sending status between bursts and idleness.

Based on collected email traces having SIPs, DIPs, time stamps, and/or other message features, two different sets of features may be extracted, referred to herein as “breadth features” and “spectral features.” Breadth features contain information about the number of EAs to which one particular SIP tries to send messages, the number bursts of email delivery seen by each EA, the total message volume in a burst, and the number of outbreaks of a SIP during a spam campaign, etc. Spectral features capture the sending pattern of a SIP. A configurable timeframe may be divided into slices, which results in a sequence of messages delivered by a SIP in each slice. This sequence may be transformed into the frequency domain using a discrete Fourier transform. Since spam senders do not typically have a regular low-frequency sending pattern in a given twenty-four hour time window, these features may be used to distinguish spam patterns from legitimate email traffic.

Note that the behavior features available to a classifier may depend upon, vary with, and/or be constrained by the types of data accessible from various sources, and the various embodiments of classifiers described herein are generally not dependent upon a particular set of behavior features. Thus, a high-level discussion of the methodology and theory behind feature selection and extraction is provided here.

To classify spam senders with a particular botnet in one embodiment of network environment 10, as may be done at 335 of flowchart 300, behavioral analysis may be extended to include both message sending behavior and message content resemblance characteristics. In general, the results of the first level classification at 325 may be taken as input to this second level classifier at 335. In order to detect which botnet a malicious SIP may belong to, heuristics may be applied to spamtrap samples collected at 320 to obtain pairs of information, <malware ID, IP>, such that each SIP is correctly labeled with a botnet name. In one embodiment, these heuristics are regular expression rules that may be applied during the mail transport protocol conversation. These regular expression rules can be derived by running malware in a sandbox environment and analyzing the messaging traffic generated by the malware for idiosyncrasies in the protocol implementation or for common content templates, for example. All of the SIPs that appear both in the labeled pairs collected from spamtraps and the behavioral feature dataset may be used for training a classifier. In addition to the features used in the first level classifier, count information for each feature element in the fingerprint for all messages may be employed. SIPs can be safely labeled with detected botnet names found in the spamtrap samples because all the SIPs in this set are known to be delivering spam.

To combine the message content features with SIP behavior features, FEs from a SIP may be aggregated. Assuming that two SIPs, SIP-a and SIP-b, are members of the same botnet and are participating in the same spam campaign, then spam messages should have highly similar content and the FEs seen for SIP-a should have a significant portion overlapping with the FEs seen for SIP-b. Similarly, assuming that typical bots do not have significant differences in resources regarding processing capacity, bandwidth, and online continuity, then both SIP-a and SIP-b should demonstrate similar sending behavior regarding the message volume, frequency, and breadth of DIPs, etc. Also, some behavioral features can be independent of capacity. Examples include the local sender time when most email activity occurs, the number of different domains in the sender address field for all messages sent by a SIP (e.g. as determined by a hash count based on reputation query data), and the average message size.

In one embodiment of network environment 10, a combination of several binary SVMs with a one-vs-one strategy may be used for analysis, although other techniques may be used as appropriate. An SVM classifier can be built for each pair of two classes (botnets), and then (N*(N−1))/2 rounds of binary classification may be repeatedly performed, where N is the number of classes (botnets) to classify. By applying a one-vs-one strategy, a SIP can be repeatedly fit to every two of the N classes. The final decision can be made by major voting—a SIP is classified in a botnet with the maximum number of votes. If there is an equal number of maximum votes, then a SIP is classified in all of the botnets with the maximum number of votes.

Note that with the examples provided above, as well as numerous other examples provided herein, interaction may be described in terms of two, three, or four network elements. However, this has been done for purposes of clarity and example only. In certain cases, it may be easier to describe one or more of the functionalities of a given set of flows by only referencing a limited number of network elements. It should be appreciated that network environment 10 is readily scalable and can accommodate a large number of components, as well as more complicated/sophisticated arrangements and configurations. Accordingly, the examples provided should not limit the scope or inhibit the broad teachings of network environment 10 as potentially applied to a myriad of other architectures. Additionally, although described with reference to particular scenarios, where a particular module, such as a behavior analyzer module, is provided within a network element, these modules can be provided externally, or consolidated and/or combined in any suitable fashion. In certain instances, such modules may be provided in a single proprietary unit.

It is also important to note that the steps in the appended diagrams illustrate only some of the possible scenarios and patterns that may be executed by, or within, network environment 10. Some of these steps may be deleted or removed where appropriate, or these steps may be modified or changed considerably without departing from the scope of teachings provided herein. In addition, a number of these operations have been described as being executed concurrently with, or in parallel to, one or more additional operations. However, the timing of these operations may be altered considerably. The preceding operational flows have been offered for purposes of example and discussion. Substantial flexibility is provided by network environment 10 in that any suitable arrangements, chronologies, configurations, and timing mechanisms may be provided without departing from the teachings provided herein.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. In order to assist the United States Patent and Trademark Office (USPTO) and, additionally, any readers of any patent issued on this application in interpreting the claims appended hereto, Applicant wishes to note that the Applicant: (a) does not intend any of the appended claims to invoke paragraph six (6) of 35 U.S.C. section 112 as it exists on the date of the filing hereof unless the words “means for” or “step for” are specifically used in the particular claims; and (b) does not intend, by any statement in the specification, to limit this disclosure in any way that is not otherwise reflected in the appended claims.

1. A method executed by a comprehensive behavioral analyzer with one or more processors, the method comprising:
receiving message sender traits associated with email senders, wherein the email senders include one or more unknown email senders and one or more malicious known email senders;
receiving a dataset of known malware identifiers and associated network addresses from a spamtrap, wherein one or more of the associated network addresses correspond to the one or more malicious known email senders; and
classifying each of the unknown email senders by the malware identifiers in the dataset, wherein each classification is based on a similarity of the message sender traits of one of the unknown email senders and the message sender traits of one of the malicious known email senders.

2. The method of claim 1, wherein the message sender traits comprise content resemblance factors.

3. The method of claim 1, wherein the message sender traits comprise behavior features.

4. The method of claim 1, wherein the message sender traits comprise content resemblance factors and behavior features.

5. The method of claim 2, wherein the content resemblance factors are message fingerprints.

6. The method of claim 2, wherein the content resemblance factors are winnowing fingerprints comprised of feature elements.

7. The method of claim 3, wherein the behavior features include breadth features and spectral features.

8. The method of claim 3, wherein the behavior features indicate message distribution of each email sender and the delivery speed of each email sender.

9. The method of claim 1, wherein the unknown email senders are classified with a supervised classifier.

10. The method of claim 1, wherein the unknown email senders are classified with a support vector machine.

11. The method of claim 2, further comprising pruning noisy feature elements from the content resemblance factors, selecting a threshold value, and pruning feature elements from the content resemblance factors if the feature elements originate from a number of email senders less than the threshold value.

12. The method of claim 4, wherein:
prior to the classification of the unknown email senders by the malware identifiers, the one or more unknown email senders are classified as malicious or benign based on the behavior features, wherein only the unknown email senders that are classified as malicious are classified by malware identifiers.

13. The method of claim 12, further comprising:
pruning noisy feature elements from the content resemblance factors, selecting a threshold value, and pruning feature elements from the content resemblance factors if the feature elements originate from a number of email senders less than the threshold value.

14. Logic encoded in one or more non-transitory tangible media that includes code for execution and when executed by one or more processors is operable to perform operations comprising:
receiving message sender traits associated with email senders, wherein the email senders include one or more unknown email senders and one or more malicious known email senders;
receiving a dataset of known malware identifiers and associated network addresses from a spamtrap, wherein one or more of the associated network addresses correspond to the one or more malicious known email senders; and
classifying each of the unknown email senders by the malware identifiers in the dataset, wherein each classification is based on a similarity of the message sender traits of one of the unknown email senders and the message sender traits of one of the malicious known email senders.

15. The logic of claim 14, wherein the message sender traits comprise content resemblance factors.

16. The logic of claim 14, wherein the message sender traits comprise behavior features.

17. The logic of claim 14, wherein the message sender traits comprise content resemblance factors and behavior features.

18. The logic of claim 15, wherein the content resemblance factors are message fingerprints.

19. The logic of claim 15, wherein the content resemblance factors are winnowing fingerprints comprised of feature elements.

20. The logic of claim 16, wherein the behavior features include breadth features and spectral features.

21. The logic of claim 14, wherein the unknown email senders are classified with a supervised classifier.

22. The logic of claim 14, wherein the unknown email senders are classified with a support vector machine.

23. The logic of claim 16, wherein:
prior to the classification of the unknown email senders by the malware identifiers, the one or more unknown email senders are classified as malicious or benign based on the behavior features, wherein only the unknown email senders that are classified as malicious are classified by malware identifiers.

24. An apparatus, comprising:
an analyzer module;
one or more processors operable to execute instructions associated with the analyzer module, the one or more processors being operable to perform further operations comprising:
receiving behavior features and content resemblance factors associated with email senders, wherein the email senders include one or more unknown email senders and one or more malicious known email senders;
receiving a dataset of known malware identifiers and associated network addresses from a spamtrap, wherein one or more of the associated network addresses correspond to the one or more malicious known email senders;
classifying one or more of the unknown email senders as malicious based on the behavior features; and
further classifying each of the malicious unknown email senders by the malware identifiers in the dataset, wherein each further classification is based on a similarity of the content resemblance factors of the malicious unknown email senders and the content resemblance factors of one of the malicious known email senders.

25. The apparatus of claim 24, wherein the content resemblance factors are message fingerprints.

26. The apparatus of claim 24, wherein the content resemblance factors are winnowing fingerprints comprised of feature elements.

27. The apparatus of claim 24, wherein the behavior features include breadth features and spectral features.

28. The apparatus of claim 24, wherein the malicious unknown email senders are further classified with a supervised classifier.

29. The apparatus of claim 24, wherein the malicious unknown email senders are further classified with a support vector machine.
